(19) United States
(12) Patent Application Publication
(10) Pub. No.: US 2007/0159863 A1
(43) Pub. Date: Jul. 12, 2007

(54) Field effect transistor of Lus Semiconductor and synchronous rectifier circuits

(76) Inventor: Chao-Cheng Lu, Taipei (TW)

Correspondence Address: LU, CHAO-CHENG, 4-4, Alley 27, Lane 143, Chun Kung Road, Taipei, 11614, TW

(21) Appl. No.: 11/333,630

(22) Filed: Jan. 9, 2006

(51) Int. Cl. H02M 5/42

(52) U.S. Cl. 363/84

(57) ABSTRACT

The Lus, Semiconductor in this invention is characterized by replacing the static shielding diode (SSD) of traditional Enhancement Mode Field Effect Transistors (EMFETs) or Depletion Mode Field Effect Transistor (DMFETs) with polarity reversed (comparing with traditional SSD) SSD, Schottky Diode, or Zener Diode, or face-to-face or back-to-back coupled Schottky Diodes, Zener Diodes, Fast Diodes, or Four Layer Devices such as DIAC and TRIAC. With the proposed Power EMFETs or DMFETs of which the drain to source resistors (Rds) are quite low, high efficiency synchronous rectification may be achieved.

### BACKGROUND OF THE INVENTION

1. Field of the Invention

This invention is related to Enhancement Mode Field Effect Transistors, EMFETs, and Depletion Mode Field Effect Transistor, DMFETs, such as IGFETs, JFETs, MESFETs, MODFETs, HEMTs and so forth, for synchronous rectifier circuits, especially EMFETs or DMFETs with novel structures replacing conventional Static Shielding Diodes, SSDs. According to this invention, traditional SSDs in EMFETs or DMFETs may be replaced with polarity reversed (comparing with traditional SSD) SSDs, Schottky Diodes, or Zener Diodes, or face-to-face/back-to-back coupled Schottky Diodes, Zener Diodes, Fast Diodes, or Four Layer Devices such as DIAC or TRIAC such that conventional functions are preserved and need only to consider the amplitude of the reverse biased voltage for proper semiconductor operating voltage. As shown in FIG. 2 (E) or (F), the amplitude of the reverse biased operating voltage, i.e. Zener Voltage, may be configured according to the needs. The set Zener voltage would be higher than the DC output voltage in actual applications according to this invention. That is, the voltage of conventional SSD in an EMFET or a DMFET is higher than the AC voltage at input side, but the Zener voltage of the polarity reversed coupling Zener Diode is higher than the DC output voltage. According to such design philosophy of this invention, half-wave synchronous rectification may be achieved with a single EMFET or DMFET in coordination with auxiliary circuits, and full-wave synchronous rectification may be achieved with two EMFETs or DMFETs in coordination with auxiliary circuits. Hence, functions of high efficiency synchronous rectification may be achieved.

2. Description of the Related Art

FIG. 3 shows a circuit of a conventional single ended forward synchronous rectifier, SR. In this figure, FET V1 is responsible for rectification while FET V2 is responsible for freewheeling. In operation, when the secondary voltage Us is at the positive half cycle, FET V1 closes and FET V2 opens, and FET V1 acts as a rectifier; when the secondary voltage Us is at the negative half cycle, FET V1 opens and FET V2 closes, and FET V1 acts as a free-wheel. The conductive power waste of FET V1 and FET V2, and the driving power waste of the gates produce the main power waste in the synchronous rectifier circuit. Such scheme comes with the following drawbacks:
1. As far as the power waste is concerned, the power lost due to the follow current results in lower efficiency of synchronous rectification.
2. As far as the cost of material is concerned, EMFETs required for synchronous rectification raises the cost of manufacture.

### SUMMARY OF THE INVENTION

In order to provide semiconductor devices, which may elevate the efficiency of rectification, this invention is proposed according to the following objects.

The first object of this invention is to provide semiconductor devices that eliminate the drawback of high power consumption of conventional synchronous rectifiers utilizing diodes, such as Schottky diodes.

The second object of this invention is to decrease the cost of manufacture due to EMFETs or DMFETs used for synchronous rectification.

In order to solve the problem of high power consumption in conventional rectifiers and voltage regulation systems, the present invention possesses the following characteristics:
1. Unlike the manufacture process of conventional EMFETs or DMFETs, the polarity of single parasitic diode, SSD, is reversed, or the conventional SSD is replaced with two of face-to-face/back-to-back coupled diodes, i.e., in the manufacture process of EMFETs or DMFETs, coupling characteristic structures of the Lus Semiconductors between drain node and source node shown in FIG. 2.
2. If no parasitic diodes exist in conventional EMFETs or DMFETs, the characteristic structures shown in FIG. 2, their permutations and combinations, and even snubber circuits may also be externally coupled between the drain nodes and source nodes to construct the Lus Semiconductors.
3. The Lus Semiconductors in the present invention may also be applied in conventional PWM and PFM power systems. Rectifier diodes may be replaced with Lus Semiconductors and the efficiency may be improved.

According to the defects of the conventional technology discussed above, a novel solution, the Lus Semiconductor, is proposed in the present invention, which provides higher efficiency in synchronous rectification.

### BRIEF DESCRIPTION OF THE DRAWINGS

FIG. 1 shows the structures of an N-Channel EMFET or DMFET and a P-Channel EMFET or DMFET of the Lus Semiconductor according to the present invention.

FIG. 2 shows characteristic circuit structures of the Lus Semiconductor coupled between the drain and source of the EMFET or DMFET shown in FIG. 1.

FIG. 3 shows a circuit of a conventional single ended forward synchronous rectifier.

FIG. 4 shows the symbols for N-Channel and P-channel Lus Semiconductors.

FIG. 5 shows one embodiment of full-wave synchronous rectifier and voltage regulation circuit utilizing EMFETs according to the present invention.

FIG. 6 shows one embodiment of half-wave synchronous rectifier and voltage regulation circuit utilizing an EMFET according to the present invention.

FIG. 7 shows one embodiment of full-wave synchronous rectifier and voltage regulation circuit utilizing DMFETs according to the present invention.

FIG. 8 shows one embodiment of half-wave synchronous rectifier and voltage regulation circuit utilizing a DMFET according to the present invention.

### DETAILED DESCRIPTION OF THE INVENTION

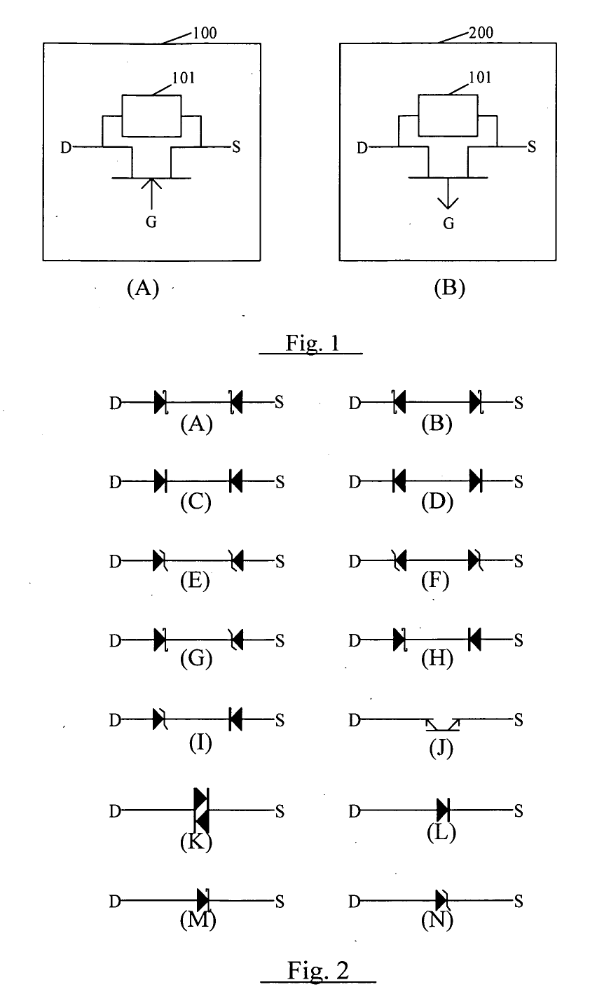

FIG. 1 shows the structures of an N-Channel EMFET or DMFET 100 and a P-Channel EMFET or DMFET 200 of Lus Semiconductor according to the present invention. FIG. 2 shows several characteristic circuit structures 101 of Lus Semiconductor that may be coupled between the drain nodes and the source nodes of EMFETs or DMFETs shown in FIG. 1. A pair of face-to-face coupled Schottky diodes and a pair of back-to-back coupled Schottky diodes are shown in FIG. 2(A) and FIG. 2(B) respectively, and each of the two may be then coupled to the drain node and the source node of the EMFETs or DMFETs. A pair of face-to-face coupled SSDs and a pair of back-to-back coupled SSDs is shown in FIG. 2(C) and FIG. 2(D) respectively, and each of the two may be then coupled to the drain node and source node of the EMFETs or DMFETs. A pair of face-to-face coupled Zener diodes and a pair of back-to-back coupled Zener diodes are shown in FIG. 2(E) and FIG. 2(F) respectively, and each of the two may be then coupled to the drain node and source node of the EMFETs or DMFETs. FIG. 2(G) shows a pair of face-to-face coupled Schottky diode and Zener diode, which may then be coupled to the drain node and the source node of the EMFETs or DMFETs. FIG. 2(H) shows a pair of face-to-face coupled Schottky diode and SSD, which may then be coupled to the drain node and the source node of the EMFETs or DMFETs. FIG. 2(I) shows a pair of face-to-face coupled Zener diode and fast diode, which may then be coupled to the drain node and the source node of the EMFETs or DMFETs. FIG. 2(J) shows a DIAC four layer semiconductor and FIG. 2(K) shows a TRIAC four layer semiconductor, each of the two may then be coupled to the drain node and the source node of the EMFETs or DMFETs. The characteristic circuit structures 101 shown in FIG. 2(A)˜(K), their permutations and combinations and snubber circuits may all be coupled to the drain node and the source node of the EMFETs or DMFETs and Lus Semiconductors 100, 200 are thus constructed. With the characteristic circuit structures 101 shown in FIG. 2(A)˜(K), their permutations and combinations and snubber circuits, high efficiency rectification and voltage regulation may be achieved, with a single EMFET or DMFET. Comparing with the structures of a conventional N-Channel EMFET or DMFET or a conventional P-Channel EMFET or DMFET, one can tell that they are the totally different from the characteristic circuit structures of the Lus Semiconductors.

FIG. 3 shows a circuit of a conventional single ended forward synchronous rectifier. Its operations were described in the description of the related art and will not be discussed here for conciseness.

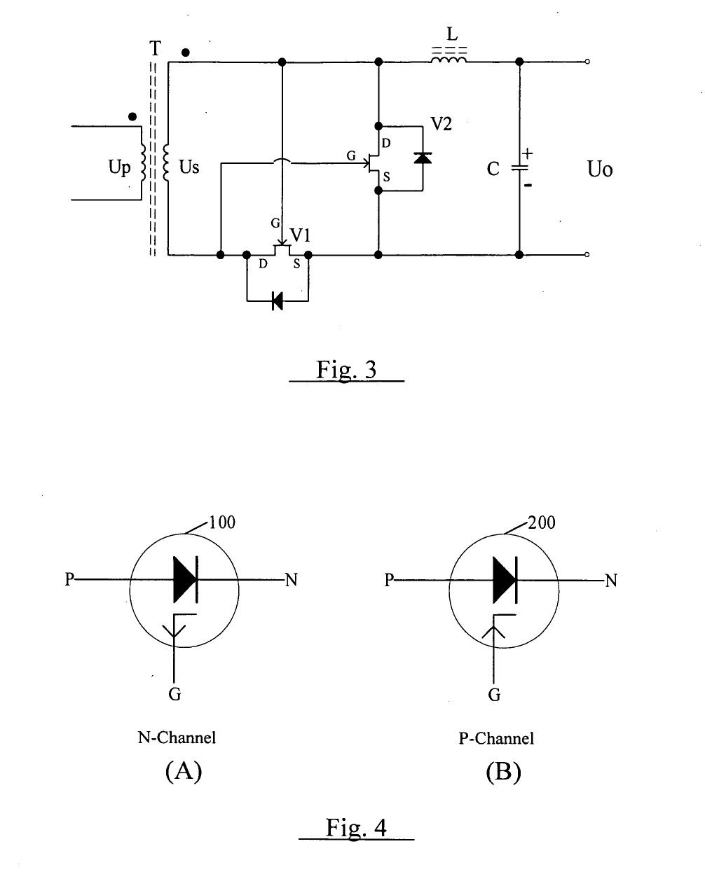

FIG. 4 shows the symbols for N-Channel and P-channel Lus Semiconductors wherein FIG. 4(A) is an N-Channel Lus Semiconductor and FIG. 4(B) is a P-Channel Lus Semiconductor wherein the P junction is the input pole, the N junction is the output pole and the G (Gate) is the control pole. The GN voltage may control the voltage drop between the P junction and the N junction such that the purpose of gate controlled voltage drop may be achieved.

FIG. 5 shows one embodiment of full-wave synchronous rectifier and voltage regulation circuit utilizing EMFETs according to the present invention. In operation, while the voltage at node 8 of the first secondary winding of the high frequency transformer 300 is at positive half cycle, the voltage at node 11 of the secondary winding is also at positive half cycle. The positive voltage at node 11 flows through diode D4 and voltage dividing resistors RG and RH. Thus the GN voltage of the Lus Semiconductor 100a equals to the voltage drop between the two ends of the voltage-dividing resistor RG. Because the RDS of the EMFETs of the Lus Semiconductor 100a is quite small, for example, RDS=5 mΩ. If the current through RDS is 10 A, then the voltage drop between the two ends of RDS is VDS=0.005(Ω)×10 (A)=0.05V. Let the saturation voltage of the diode of the characteristic circuit 101 be VF=0.7V, comparing VDS with VF, the diode of the characteristic circuit can be found open, thus the voltage drop between the two ends of the voltage dividing resistor RG conducts the drain and source of the Lus Semiconductors 100a. The positive half cycle AC voltage at node 8 passes through the drain and source of the Lus Semiconductor 100a and a π-type filter constructed with a filter capacitor C2, an inductor L1 and a filter capacitor C3, thus becomes DC output voltage Vo. While the AC voltage at the node 10 of the first secondary winding of the high frequency transformer 300 is at positive half cycle, the voltage at node 13 of the secondary winding is also at positive half cycle. The positive voltage at node 13 flows through diode D5 and voltage dividing resistors RG and RH. Thus the GN voltage of the Lus Semiconductor 100b equals to the voltage drop between the two ends of the voltage-dividing resistor RG. Because the RDS of the EMFETs of the Lus Semiconductor 100b is quite small, the voltage drop between the two ends of the voltage-dividing resistor RG conducts the drain and source of the Lus Semiconductors 100b. The middle node of the second secondary winding is at node 12 which is also coupling to node N, thus formed a complete gate controlled circuit. The operation is identical to that while the AC voltage at the node 8 of the first secondary winding of the high frequency transformer 300 is at positive half cycle. Because those two half-cycle circuits are commonly connected at node N, full-wave rectification may be achieved. While the output voltage Vo is higher than a pre-defined voltage, an adjustable precision shunt regulator integrated circuit IC1 may be activated, and meanwhile the collector and the emitter at the output side of a photo coupler Ph0 may be conducted that decreases the duty cycle of the output wave of the PWM control circuit and lower the output voltage Vo to the predetermined voltage; while the output voltage Vo drops, IC1 deactivates and increase the duty cycle of the output wave of the PWM control circuit and thus raise the output voltage Vo. According to the operation, the Lus Semiconductors 100a, 100b are capable of rectification. While the voltage at node 8 of the high frequency transformer 300 is set to be positive, let the reverse biased break down voltage of the diode of the characteristic circuit structure 101a of the Lus Semiconductor 100a is higher than the positive voltage at node 8, thus the voltage at node 8 may not pass through the reversed diode but through the drain and source of the Lus Semiconductor 100a. While the output voltage Vo is present, even though the voltage at node 8 is at the negative half cycle of the AC voltage, because the reverse biased break down voltage of the reverse coupled Schotty diode in the characteristic circuit structure 101a is higher than the output voltage Vo, the possibility that the first secondary winding may be burned out by the reverse current of conventional EMFETs can be eliminated. The operation of the characteristic circuit structure 101b in the Lus Semiconductor 100b at node 10 is identical. According to the operation of the characteristic circuit structure 101 in the present invention, the reverse biased break down voltage may be configured according to applications and shall not be limited. The operations of voltage regulation in PWM or PFM power systems are known to person skilled in the art and will not be discussed here for conciseness.

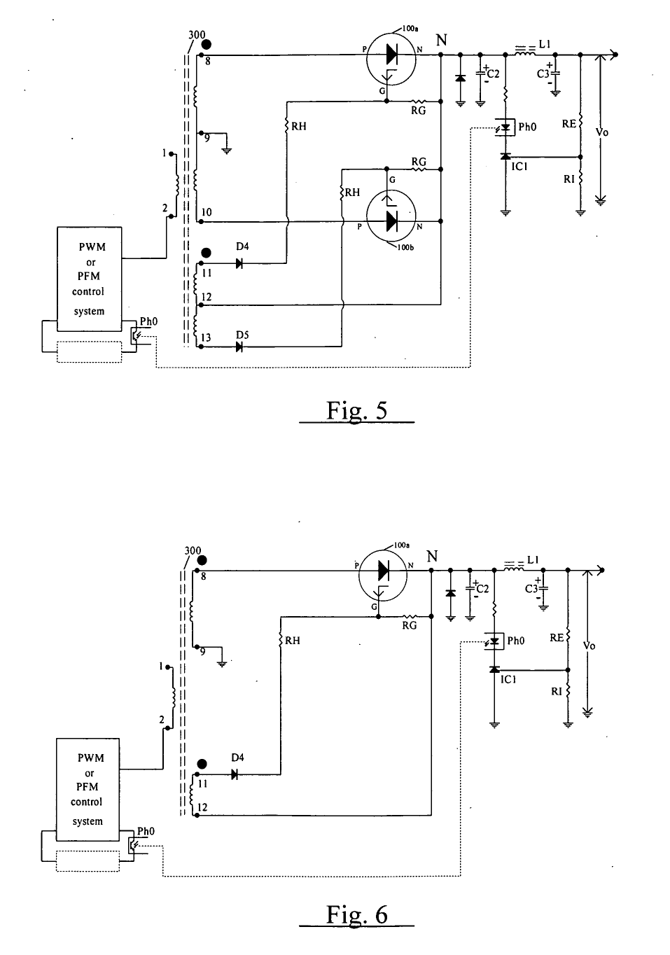

FIG. 6 shows one embodiment of half-wave synchronous rectifier and voltage regulation circuit utilizing an EMFET according to the present invention. As shown in the figure, the Lus Semiconductor 100b, node 10 of the first secondary winding and node 13 of the second secondary winding shown in FIG. 5 were removed and thus became a half-wave synchronous rectifier and voltage regulation circuit. The operation of the circuit is identical to that of the Lus Semiconductor 100a shown in FIG. 5 and will not be discussed here for conciseness.

FIG. 7 shows one embodiment of full-wave synchronous rectifier and voltage regulation circuit utilizing DMFETs according to the present invention. The difference between the full-wave synchronous rectifier and voltage regulation circuit utilizing EMFETs shown in FIG. 5 and the full-wave synchronous rectifier and voltage regulation circuit utilizing DMFETs shown in FIG. 7 is that DMFETs need a negative voltage supply circuit for the gates to maintain the source and the drain open, such that no source-drain current is developed. The negative voltage supply circuit is constructed with diodes D6, D7, D8, voltage dividing resistors RJ, RG, and a filter capacitor C4. The node 14 and node 15 of the third secondary winding are the power source of the negative voltage supply circuit. Diode D6 functions as a rectifier. Diode D7 and D8 prevent the secondary winding from affecting the negative voltage supply circuit of the asynchronous rectification side while the synchronous rectifier is in operation. In short, the operation and structures of the full-wave synchronous rectifier and voltage regulation circuit utilizing EMFETs shown in FIG. 5 and the full-wave synchronous rectifier and voltage regulation circuit utilizing DMFETs shown in FIG. 7 are identical except for the negative voltage required for the gates of DMFETs in FIG. 7.

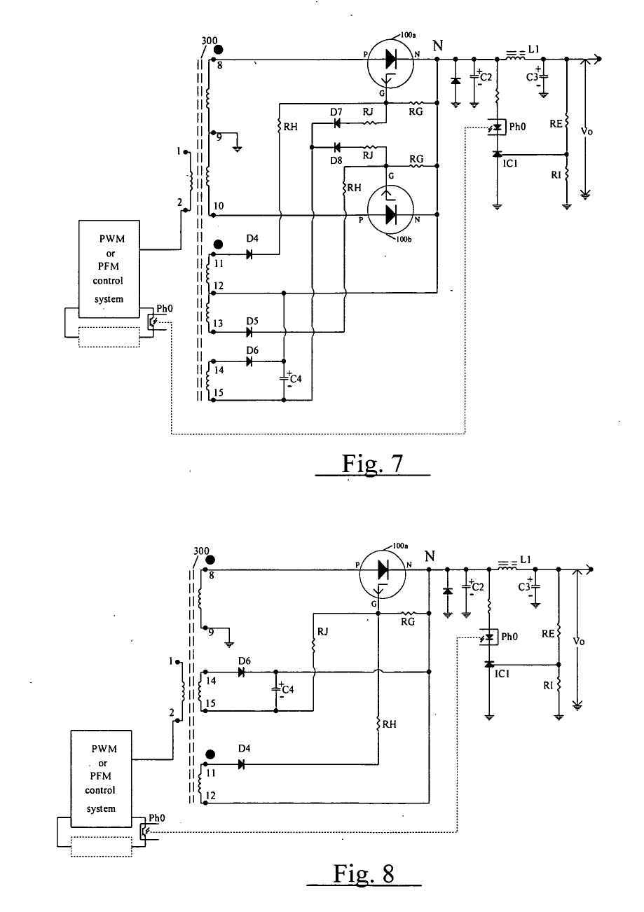

FIG. 8 shows one embodiment of half-wave synchronous rectifier and voltage regulation circuit utilizing a DMFET according to the present invention. As shown in the figure, the Lus Semiconductor 100b, node 10 of the first secondary winding and node 13 of the second secondary winding shown in FIG. 7 were removed and thus became a half-wave synchronous rectifier and voltage regulation circuit. The operation of the circuit is identical to that of the Lus Semiconductor 100a shown in FIG. 7 and will not be discussed here for conciseness.

It is further stated that EMFETs and DMFETs, like ordinary transistors, are bidirectional, i.e. the drain nodes and the source nodes of the Lus Semiconductors 100a, 100b in FIG. 5, FIG. 6, FIG. 7, or FIG. 8 may be reversed while the characteristic of gate-source operating voltage and the characteristic circuits are still maintained. That is, in application, the gate node may be the control node, the source node may be the AC input node and the drain node may be the DC output node, depending on the specifications of the manufacturer, the drain node and the source node may be alternated and is not limited by the embodiments above.

What is claimed is:

1. A power semiconductor device for synchronous rectification comprising a gate node, a drain node and a source node, wherein at least one characteristic circuit being coupled between said drain node and said source node of an EMFET or a DMFET.

2. The power semiconductor device according to claim 1, wherein said characteristic circuit is chosen from the group consisting of a pair of back-to-back or face-to-face series coupling Schotty diodes, a pair of back-to-back or face-to-face series coupling SSDs, a pair of back-to-back or face-to-face series coupling Zener diodes, a pair of back-to-back or face-to-face series coupling Schotty diode and Zener diode, a pair of back-to-back or face-to-face series coupling Schotty diode and SSD, a pair of back-to-back or face-to-face series coupling Zener diode and SSD, a four layer semiconductor device and permutations and combinations thereof, wherein said back-to-back coupling means P-type nodes interconnecting and said face-to-face coupling means N-type nodes interconnecting.

3. The power semiconductor device according to claim 2, wherein said four layer semiconductor device is a piece of DIAC or TRIAC.

4. The power semiconductor device according to claim 1, wherein said characteristic circuit comprising a P-type node and an N-type node that coupling respectively to said drain node and said source node of said EMFET or said DMFET.

5. The power semiconductor device according to claim 4 wherein said characteristic circuit is one fast diode, one Schotty diode, one Zener diode or permutations and combinations thereof.

6. The power semiconductor device according to claim 1 wherein said drain node and said source node may be reversed while characteristics of gate-source operating voltage and characteristic circuits of said EMFET or said DMFET are still maintained; and said gate node may be a control node, said source node may be an AC input node and said drain node may be a DC output node, depending on specifications of manufacturer.

7. The power semiconductor device according to claim 1 wherein said EMFET or said DMFET may be an IGFET, a JFET, an MESFET, an MODFET or an HEMT.

8. A synchronous rectifier circuit utilizing at least one EMFETs for rectifying a power source, comprising:
a primary winding for receiving said power source;
a first secondary winding coupling to at least one power semiconductor device as in any preceding claims; and
a second secondary winding coupling to said power semiconductor device for providing said power semiconductor device operation voltage; wherein:
said power semiconductor device synchronously rectifying said power source and thus an output voltage is obtained.

9. The synchronous rectifier circuit according to claim 8, further comprising:
a sensor circuit sampling said output voltage;
a feedback circuit coupling to said sensor circuit for providing a feedback signal according to sampled output voltage of said sensor circuit; and
a control circuit coupling to say feedback circuit for adjusting said output voltage to a predetermined value according to said feedback signal.

10. The synchronous rectifier circuit according to claim 9 wherein said control circuit is a PWM control system or a PFM control system.

11. The synchronous rectifier circuit according to claim 9 wherein said sensor circuit is a voltage dividing circuit.

12. The synchronous rectifier circuit according to claim 9 wherein said feedback circuit further comprising:
an adjustable precision shunt regulator integrated circuit coupling to said sensor circuit for receiving sampled output voltage from said sensor circuit; and
a photo coupler being controlled by said adjustable precision shunt regulator integrated circuit and coupling to say control circuit.

13. The synchronous rectifier circuit according to claim 12 wherein while said output voltage getting higher than a predetermined voltage, said adjustable precision shunt regulator integrated circuit activates and conducts the collector and the emitter of the output side of said photo coupler such that said feedback signal being transferred to said control circuit and lowering said output voltage; while said output voltage getting lower, said adjustable precision shunt regulator integrated circuit deactivates such raising said output voltage.

14. The synchronous rectifier circuit according to claim 8, further comprising a filter circuit for said output voltage.

15. The synchronous rectifier circuit according to claim 8 wherein said synchronous rectifier circuit is capable of half-wave synchronous rectification.

16. The synchronous rectifier circuit according to claim 8 wherein said synchronous rectifier circuit is capable of full-wave synchronous rectification.

17. A synchronous rectifier circuit utilizing at least one DMFETs for rectifying a power source, comprising:
a primary winding for receiving said power source;
a first secondary winding coupling to at least one power semiconductor device as in any preceding claims; and
a second secondary winding coupling to said power semiconductor device for providing said power semiconductor device operation voltage; wherein:
said power semiconductor device synchronously rectifying said power source and thus an output voltage is obtained.

18. The synchronous rectifier circuit according to claim 17, further comprising:
a sensor circuit sampling said output voltage;
a feedback circuit coupling to said sensor circuit for providing a feedback signal according to sampled output voltage of said sensor circuit; and
a control circuit coupling to say feedback circuit for adjusting said output voltage to a predetermined value according to said feedback signal.

19. The synchronous rectifier circuit according to claim 17 wherein said control circuit is a PWM control system or a PFM control system.

20. The synchronous rectifier circuit according to claim 17 wherein said sensor circuit is a voltage dividing circuit.

21. The synchronous rectifier circuit according to claim 17 wherein said feedback circuit further comprising:
an adjustable precision shunt regulator integrated circuit coupling to said sensor circuit for receiving sampled output voltage from said sensor circuit; and
a photo coupler being controlled by said adjustable precision shunt regulator integrated circuit and coupling to say control circuit.

22. The synchronous rectifier circuit according to claim 21 wherein while said output voltage getting higher than a predetermined voltage, said adjustable precision shunt regulator integrated circuit activates and conducts the collector and the emitter of the output side of said photo coupler such that said feedback signal being transferred to said control circuit and lowering said output voltage; while said output voltage getting lower, said adjustable precision shunt regulator integrated circuit deactivates such raising said output voltage.

23. The synchronous rectifier circuit according to claim 17, further comprising a filter circuit for said output voltage.

24. The synchronous rectifier circuit according to claim 17 wherein said synchronous rectifier circuit is capable of half-wave synchronous rectification.

25. The synchronous rectifier circuit according to claim 17 wherein said synchronous rectifier circuit is capable of full-wave synchronous rectification.
